(19) United States
(12) Patent Application Publication
(10) Pub. No.: US 2016/0341170 A1
(43) Pub. Date: Nov. 24, 2016

(54) IGNITION APPARATUS

(71) Applicant: HONDA MOTOR CO., LTD., Tokyo (JP)

(72) Inventors: Atsushi OTA, Wako (JP); Shigeru AOKI, Wako (JP); Akifumi YAMASHITA, Wako (JP)

(73) Assignee: HONDA MOTOR CO., LTD., Tokyo (JP)

(21) Appl. No.: 15/084,490

(22) Filed: Mar. 30, 2016

(30) Foreign Application Priority Data
May 19, 2015 (JP) 2015-101909

(51) Int. Cl. F02P 5/14; F01N 3/10; F02M 26/49; F02P 9/00

(52) U.S. Cl. CPC F02P 5/14; F02P 9/007; F01N 3/101; F02M 26/49

(57) ABSTRACT

An ignition apparatus for an internal combustion engine includes a non-equilibrium plasma discharge device, an arc discharge device, a combustion stability determination device, and a control device. The non-equilibrium plasma discharge device discharges at a non-equilibrium plasma discharge timing. The arc discharge device discharges at an arc discharge timing. The combustion stability determination device determines whether a combustion stability is lower than a threshold combustion stability. The a control device controls the non-equilibrium plasma discharge timing and the arc discharge timing to retard the arc discharge timing from the non-equilibrium plasma discharge timing by a retard angle. The a control device increases the retard angle in a case where the combustion stability determination device determines the combustion stability is lower than the threshold combustion stability.

### CROSS-REFERENCE TO RELATED APPLICATIONS

The present application claims priority under 35 U.S.C. §119 to Japanese Patent Application No. 2015-101909, filed May 19, 2015, entitled “Ignition Device for Internal Combustion Engine.” The contents of this application are incorporated herein by reference in their entirety.

### BACKGROUND

1. Field

The present invention relates to an ignition apparatus.

2. Description of the Related Art

Enhancing the degree of constant volume by increasing the combustion rate is effective for enhancing the thermal efficiency of an internal combustion engine. It has been known that in order to increase the combustion rate, discharge that generates non-equilibrium plasma (low-temperature plasma) by corona discharge or glow discharge (hereinafter referred to as non-equilibrium plasma discharge) is performed for an ignition plug, arc discharge is applied to a plasma atmosphere, and combustion of air-fuel mixture may thereby be improved.

As a control method of an internal combustion engine for an automobile that includes an ignition plug of a spark ignition type, a technique has been known in which the air-fuel mixture is ignited by spark discharge by the ignition plug until a catalyst is activated, after the catalyst is activated, an electric field generated in a combustion chamber is allowed to react with the spark discharge by the ignition plug to generate plasma in the combustion chamber, and the air-fuel mixture is thereby ignited (see Japanese Patent No. 5208062). In this technique, a rise in an exhaust gas temperature by the spark discharge is given priority over a combustion improvement by plasma immediately after a start, and the catalyst is thereby activated quickly.

Further, as a control method of the ignition plug that is capable of switching between a discharge mode which generates low-temperature plasma (non-equilibrium plasma) and a discharge mode which generates thermal plasma, a technique has also been known in which in a case where the cooling water temperature of the internal combustion engine or the oil temperature of engine oil is lower than a prescribed temperature, the thermal plasma is generated by the arc discharge to ignite the air-fuel mixture, and after the temperature becomes the prescribed temperature or higher, the low-temperature plasma is generated by the corona discharge to ignite the air-fuel mixture (see Japanese Unexamined Patent Application Publication No. 2013-238129). Japanese Unexamined Patent Application Publication No. 2013-238129 discloses that at least one of the low-temperature plasma and the thermal plasma is generated in accordance with the gas density in a cylinder to ignite the air-fuel mixture, that both of the low-temperature plasma and the thermal plasma are simultaneously generated in a case where both of the plasmas are generated, and so forth.

In addition, as an ignition device for an internal combustion engine in which two ignition plugs, which are for ignition by the low-temperature plasma and for ignition by the thermal plasma, are mounted on a cylinder head, a configuration has been known in which the ignition plug for the low-temperature plasma is arranged at the center of a top portion of the combustion chamber and the ignition plug for the thermal plasma is arranged in an outer peripheral portion of the top potion of the combustion chamber (see FIG. 14 of Japanese Unexamined Patent Application Publication No. 2013-238129 and FIG. 3 of Japanese Unexamined Patent Application Publication No. 2013-238130).

### SUMMARY

According to one aspect of the present invention, an ignition apparatus for an internal combustion engine includes a non-equilibrium plasma discharge unit, an arc discharge unit, and a control device. The control device controls a non-equilibrium plasma discharge timing and an arc discharge timing which is set to a retard side by a prescribed retard angle with respect to the non-equilibrium plasma discharge timing. In an operation state where combustion stability is low compared to a usual operation, the control device increases the retard angle compared to the usual operation.

According to another aspect of the present invention, an ignition apparatus for an internal combustion engine includes a non-equilibrium plasma discharge device, an arc discharge device, a combustion stability determination device, and a control device. The non-equilibrium plasma discharge device discharges at a non-equilibrium plasma discharge timing. The arc discharge device discharges at an arc discharge timing. The combustion stability determination device determines whether a combustion stability is lower than a threshold combustion stability. The a control device controls the non-equilibrium plasma discharge timing and the arc discharge timing to retard the arc discharge timing from the non-equilibrium plasma discharge timing by a retard angle. The a control device increases the retard angle in a case where the combustion stability determination device determines the combustion stability is lower than the threshold combustion stability.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 is a schematic cross-sectional view of an internal combustion engine that includes an ignition device according to a first embodiment.

FIGS. 2A to 2D are explanation diagrams of a combustion process by the ignition device illustrated in FIG. 1.

FIG. 3A is a graph that represents the correlation between a retard angle of an arc discharge timing with respect to a non-equilibrium plasma discharge timing and an ignition delay, and FIG. 3B is a graph that represents the correlation between the retard angle of the arc discharge timing with respect to the non-equilibrium plasma discharge timing and thermal loss.

FIG. 4 is a flowchart of discharge control subsequent to an engine start that is performed by a control device illustrated in FIG. 1.

FIG. 5 is a flowchart of discharge control in a usual operation that is performed by the control device illustrated in FIG. 1.

FIG. 6A is a graph that represents the correlation between the retard angle and combustion stability, FIG. 6B is a graph that represents the correlation between the retard angle and a catalyst temperature, and FIG. 6C is a graph that represents the correlation between the retard angle and an HC emission amount.

FIG. 7 is a schematic cross-sectional view of an internal combustion engine that includes an ignition device according to a modification example.

FIG. 8 is an enlarged cross-sectional view of main portions of an ignition plug illustrated in FIG. 7.

FIG. 9 is a schematic cross-sectional view of an internal combustion engine that includes an ignition device according to a second embodiment.

FIG. 10 is a bottom view of a top portion of a combustion chamber as seen in the X direction in FIG. 9.

FIGS. 11A to 11C are explanation diagrams of a combustion process by the ignition device illustrated in FIG. 9.

### DESCRIPTION OF THE EMBODIMENTS

The embodiments will now be described with reference to the accompanying drawings, wherein like reference numerals designate corresponding or identical elements throughout the various drawings.

Embodiments of the present disclosure will hereinafter be described with reference to drawings. In the description made below, an internal combustion engine 1 that is installed in a vehicle in accordance with the illustrated direction and an ignition device 10 of the internal combustion engine 1 will be described. However, the installation position of the internal combustion engine 1 is not limited to the illustrated position.

### First Embodiment

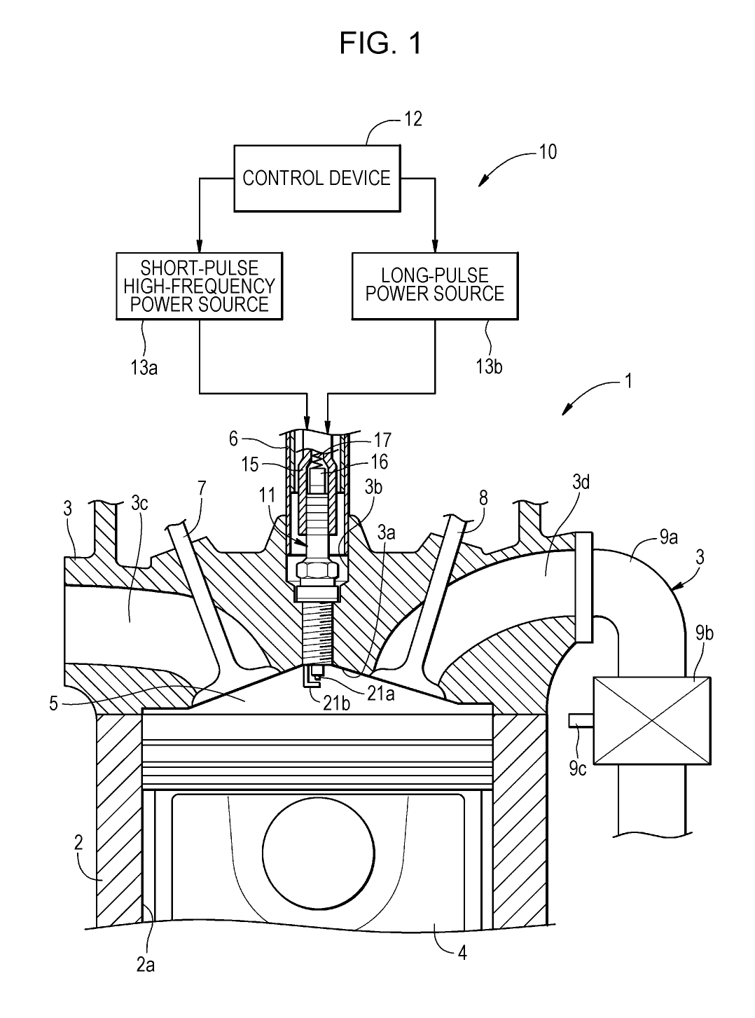

The ignition device 10 of the internal combustion engine 1 according to the first embodiment will first be described with reference to FIGS. 1 to 9. As illustrated in FIG. 1, the internal combustion engine 1 is a four-stroke gasoline engine and includes a cylinder block 2 that demarcates a cylindrical cylinder 2a, a cylinder head 3 that is joined to an upper surface of the cylinder block 2, a piston 4 that is slidably provided in the cylinder 2a, and so forth. The number of the cylinders and the arrangement of cylinder banks of the internal combustion engine 1 may arbitrarily be set.

A combustion chamber recess 3a, which is a curved recess, is formed in a position on a lower surface of the cylinder head 3 that corresponds to the cylinder 2a. A combustion chamber 5 is formed with a space that is surrounded by the combustion chamber recess 3a, the cylinder 2a, and a top surface of the piston 4. That is, the combustion chamber recess 3a defines a top portion of the combustion chamber 5.

An ignition plug insertion hole 3b that starts from an upper surface of the cylinder head 3 and reaches the combustion chamber 5 is formed at a general center of the cylinder head 3. In this embodiment, one ignition plug insertion hole 3b is formed for one cylinder 2a. The ignition plug insertion hole 3b is formed on a cylinder axis so as to open at the center of the combustion chamber recess 3a. A tubular plug guide 6 is press-fit in the ignition plug insertion hole 3b of the cylinder head 3, and the ignition plug insertion hole 3b is extended upward by the plug guide 6.

Further, an intake port 3c that opens at a left side surface of the cylinder head 3 and at the combustion chamber recess 3a and an exhaust port 3d that opens at the combustion chamber recess 3a and at a right side surface of the cylinder head 3 are formed in the cylinder head 3. In this embodiment, two intake ports 3c and two exhaust ports 3d are formed for one cylinder 2a. Intake valves 7 that open or close the respective intake ports 3c and exhaust valves 8 that open or close the respective exhaust ports 3d are slidably provided in the cylinder head 3.

An exhaust device 9 is joined to the right side surface of the cylinder head 3. The exhaust device 9 includes a catalytic converter 9b and a muffler (not illustrated) in the order from the upstream side of an exhaust passage, as well as exhaust pipe 9a that is connected with the exhaust port 3d and forms the exhaust passage. The catalytic converter 9b may be a three-way catalyst, for example. The catalytic converter 9b is provided with a temperature sensor 9c that detects a catalyst temperature.

The internal combustion engine 1 is provided with the ignition device 10 that ignites mixed gases that is taken into the combustion chamber 5 through the intake port 3c. The ignition device 10 includes an ignition plug 11 that is inserted in the ignition plug insertion hole 3b and is mounted on the cylinder head 3 such that a tip is ejected or protruded into the combustion chamber 5 and a control device 12 that controls a voltage applied from a power source 13 (13a and 13b) to the ignition plug 11. The ignition plug 11 is screwed in a female thread formed in a lower portion of the ignition plug insertion hole 3b. In this embodiment, a short-pulse high-frequency power source 13a and a long-pulse power source 13b are provided as the power source 13, and the control device 12 controls the voltage applied from both of the power sources 13a and 13b to the ignition plug 11.

A base end of the ignition plug 11 is held by a plug cap 15, and the ignition plug 11 is screwed in the female thread formed in the lower portion of the ignition plug insertion hole 3b. A terminal portion 16 is formed at the base end (upper end) of the ignition plug 11. A high-voltage conductive member 17, which is formed of a coil spring housed in an internal portion of the plug cap 15, elastically contacts with the terminal portion 16, and the terminal portion 16 is electrically connected with the power source 13.

A first electrode 21a and a second electrode 21b are provided at the tip (lower end) of the ignition plug 11. The first electrode 21a arranged on the central axis of the ignition plug 11 is a center electrode which is electrically connected with the power source 13 via the terminal portion 16 and to which a high voltage is applied. A second electrode 21b that extends from an outer peripheral portion of the ignition plug 11 and bends to be opposed to the center electrode is a ground electrode that is electrically connected with the cylinder head 3.

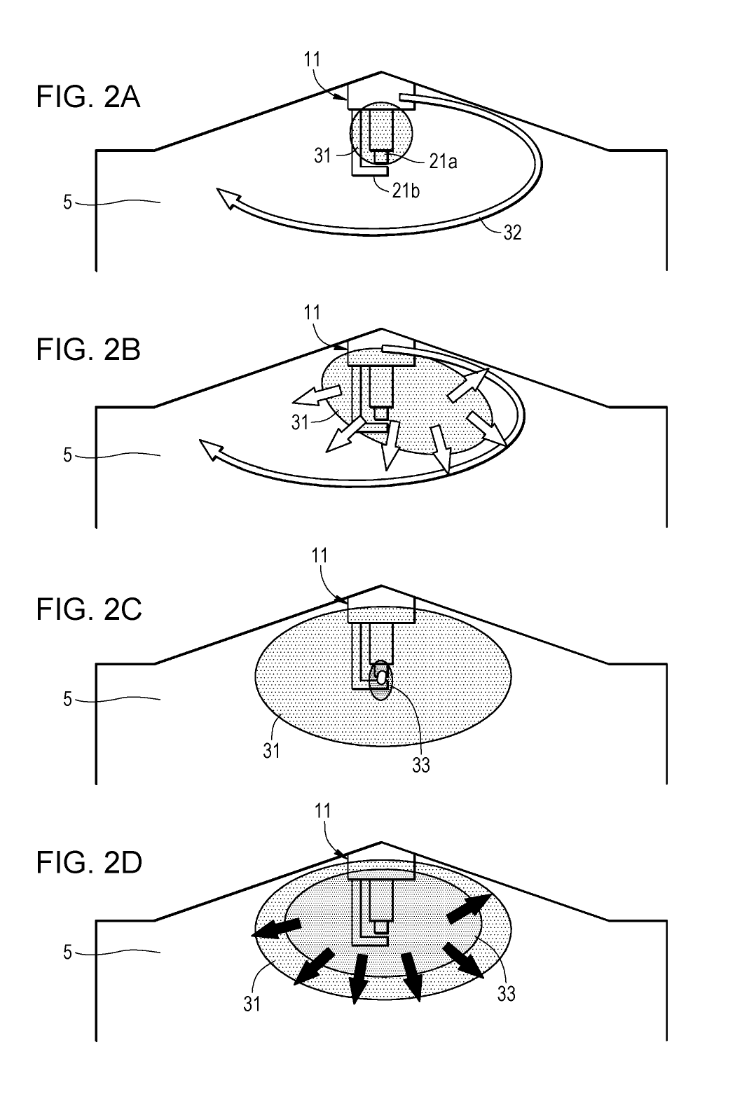

In the ignition device 10 configured as described above, the control device 12 controls the applied voltage, the pulse width of the applied voltage, and so forth of the ignition plug 11 and thereby switches the discharge modes of a pair of electrodes 21 between non-equilibrium plasma discharge and arc discharge, and air-fuel mixture is ignited by the arc discharge. Ignition of the mixed gases by the ignition plug 11 and combustion of the ignited mixed gases progress as described below. That is, as illustrated in FIG. 2A, the ignition plug 11 first performs the non-equilibrium plasma discharge with generation of the non-equilibrium plasma. Accordingly, the non-equilibrium plasma that generates radicals generates an active field 31 around the tip of the ignition plug 11. In the combustion chamber 5, the pressure is high because the piston 4 has moved to a close position to the top dead center, and a main flow 32 of high pressure air-fuel mixture is generated as indicated by the arrow.

As illustrated in FIG. 2B, the active field 31 is moved by the main flow 32 of the air-fuel mixture and spreads in the combustion chamber 5, keeps being generated by continuous discharge, and is thereby expanded. As illustrated in FIG. 2C, the ignition plug 11 thereafter performs the arc discharge and thereby ignites the air-fuel mixture. As illustrated in FIG. 2D, a flame 33 ignited at the tip (between the pair of electrodes 21) of the ignition plug 11 speedily propagates in the active field 31 while spreading from the center of the combustion chamber 5, and combustion of the air-fuel mixture is quickly completed.

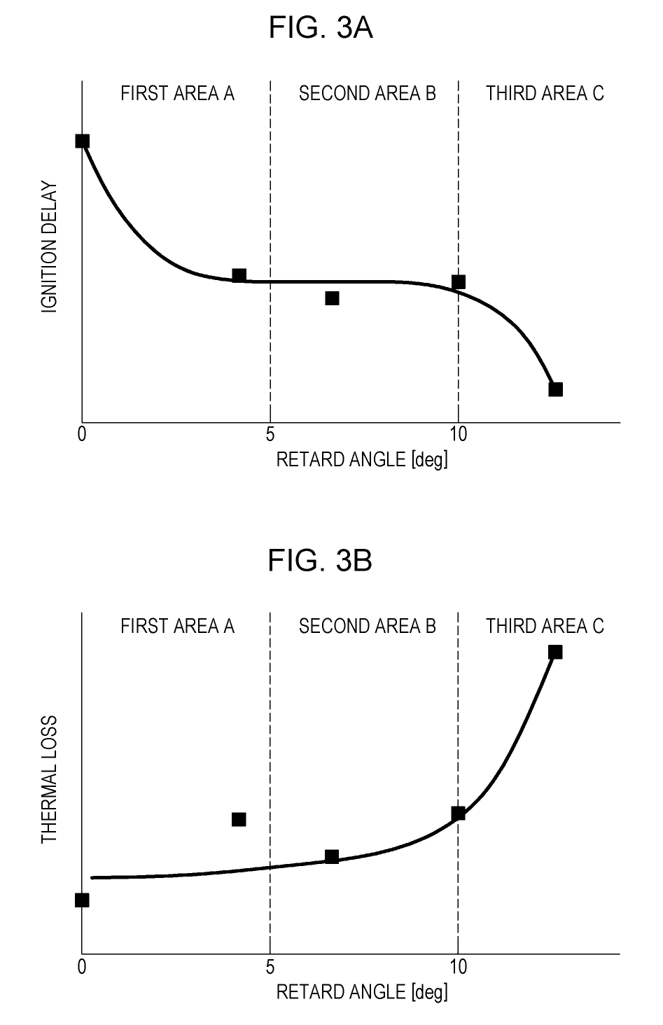

Here, a description will be made about the influence by a delay in the start timing of the arc discharge with respect to the start timing of the non-equilibrium plasma discharge (hereinafter referred to as “retard angle” with a crank angle being a reference). The retard angle is 0° or larger and does not include negative values (advance angles). FIG. 3A represents the relationship between the retard angle and an ignition delay. An ignition delay is a time from the start of the arc discharge to the ignition of the air-fuel mixture, and the shorter ignition delay means the higher ignitability of the air-fuel mixture. Thus, the ignition delay is preferably short. FIG. 3B represents the relationship between the retard angle and thermal loss. The thermal loss is preferably small.

As illustrated in FIG. 3A, the ignition delay tends to become shorter as the retard angle becomes larger. However, the change in the ignition delay with respect to the change in the retard angle (that is, the slope) is small in a range of retard angles of approximately 5° to 10°. That is, the increase rate of the ignition delay with respect to the reduction in the retard angle rapidly changes at retard angles around 5° (the slope (the absolute value of a negative value) increases as the retard angle decreases). The reduction rate of the ignition delay with respect to the increase in the retard angle rapidly changes at retard angles around 10° (the slope (the absolute value of a negative value) increases as the retard angle increases).

On the other hand, as illustrated in FIG. 3B, the thermal loss tends to become larger as the retard angle becomes larger, and the increase rate of the thermal loss with respect to the increase in the retard angle rapidly changes in an area where the retard angle is large (at a retard angle of approximately 10°) (that is, the slope (positive value) increases). That is, the retard angle is preferably large in view of the ignition delay. However, the retard angle is preferably small in view of the thermal loss. The ignition delay and the thermal loss are in a trade-off relationship.

The retard angle that exhibits such characteristics may be categorized into three areas as described below. A first area A is an angle range which starts from a retard angle of 0° and in which the ignition delay decreases as the retard angle increases (for example, 0° to 5°). A second area B is an angle range which abuts the first area A on the larger retard angle side and in which the change in the ignition delay with respect to the change in the retard angle (the slope) is relatively small (for example, 5° to 10°). A third area C is an angle range which abuts the second area B on the larger retard angle side and in which the ignition delay decreases as the retard angle increases (for example, 10° to 15°). As illustrated in FIG. 3B, it may be considered that the first area A and the second area B are the angle ranges in which the change in the thermal loss (increase) with respect to the change in the retard angle (increase), that is, the slope is relatively small and the third area C is the angle range in which the change in the thermal loss (increase) with respect to the change in the retard angle (increase), that is, the slope is relatively large.

Based on such characteristics of the retard angle, the control device 12 controls a non-equilibrium plasma discharge timing and an arc discharge timing as described below.

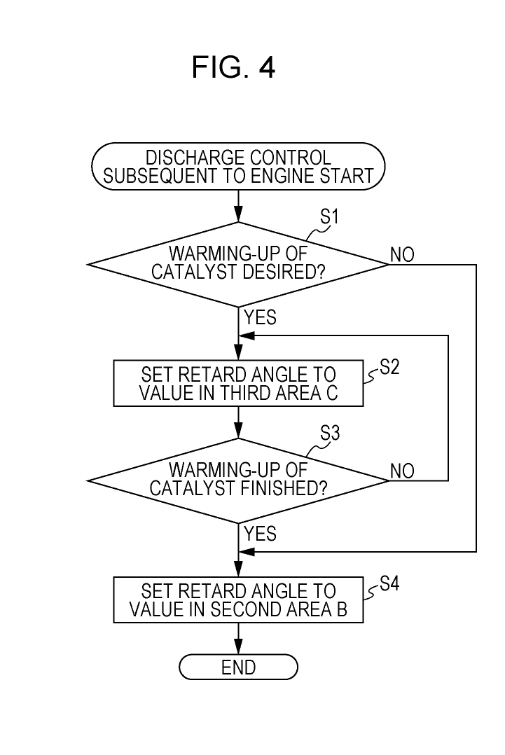

A description will first be made about a procedure of discharge control subsequent to an engine start with reference to FIG. 4. When the engine starts, the control device 12 first determines whether or not warming-up of a catalyst is desired based on a detection result of the temperature sensor 9c (step S1). In this determination, a determination is made that the warming-up of the catalyst is not desired in a case where the catalyst temperature is equal to or higher than a prescribed threshold value, and a determination is made that the warming-up of the catalyst is desired in a case where the catalyst temperature is lower than the prescribed threshold value. In a case where a determination is made that the warming-up of the catalyst is not desired in step S1 (No), in step S4, the control device 12 sets the retard angle to a prescribed value in the second area B (for example, 5° to 10°) and finishes the control. The retard angle is set to a value in the second area B in a case where a determination is made that the warming-up of the catalyst is not desired, and enhancement of both of thermal efficiency and ignitability is thereby expected (see FIGS. 3A and 3B).

On the other hand, in a case where a determination is made that the warming-up of the catalyst is desired in step S1 (Yes), the control device 12 sets the retard angle to a prescribed value in the third area C (for example, 10° or larger) (step S2). The retard angle is set to a value in the third area C in a case where a determination is made that the warming-up of the catalyst is desired, reduction in the ignition delay is thereby given priority over an increase in the thermal loss (see FIGS. 3A and 3B), and the ignitability of the air-fuel mixture is secured. The control device 12 thereafter determines whether or not the warming-up of the catalyst is completed (step S3). This determination is made based on the detection result of the temperature sensor 9c, for example. A determination threshold value for completion of the warming-up of the catalyst may be the same value as the threshold value used for the determination in step S1 but may be a larger value than the determination threshold value of step S1 in consideration of a detection error.

In a case where a determination is made that the warming-up of the catalyst is not completed in step S3 (No), the control device 12 repeats a process of step S2 and subsequent processes. That is, the retard angle is maintained at a value in the third area C, and the ignitability of the air-fuel mixture is secured. On the other hand, in a case where a determination is made that the warming-up of the catalyst is completed in step S3 (Yes), in step S4, the control device 12 sets the retard angle to a prescribed value in the second area B (for example, 5° to 10°) and finishes the control. Accordingly, enhancement of both of the thermal efficiency and ignitability is expected.

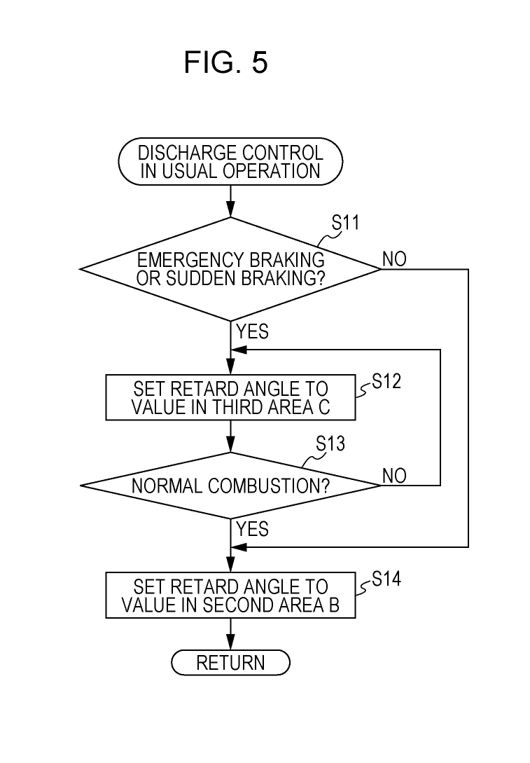

A description will next be made about a procedure of discharge control in a usual operation that is performed after the above discharge control subsequent to the engine start is finished with reference to FIG. 5. After the control device 12 finishes the discharge control subsequent to the engine start, the control device 12 determines whether or not emergency braking or sudden braking is performed (step S11). In this determination, when the vehicle is recognized to be traveling based on a vehicle speed detected by a vehicle sensor, which is not illustrated, a determination is made that emergency braking occurs in a case where the increasing rate of a brake pressure detected by a brake pressure sensor, which is not illustrated, becomes equal to or higher than a prescribed threshold value, and a determination is made that sudden braking occurs in a case where the brake pressure becomes equal to or higher than a prescribed threshold value. In a case where a determination is made that emergency braking or sudden braking does not occur in step S11 (No), the control device 12 assumes that the usual operation is performed, sets the retard angle to a prescribed value in the second area B (for example, 5° to 10°) in step S14, and repeats the above procedure. The retard angle is set to a value in the second area B in the usual operation such as a state where the vehicle stands still and usual traveling, and enhancement of both of the thermal efficiency and ignitability is thereby expected (see FIGS. 3A and 3B).

On the other hand, in a case where a determination is made that emergency braking or sudden braking occurs in step S11 (Yes), the control device 12 sets the retard angle to a prescribed value in the third area C (for example, 10° or larger) (step S12). The retard angle is set to a value in the third area C in a case where a determination is made that emergency braking or sudden braking occurs, reduction in the ignition delay is thereby given priority over an increase in the thermal loss (see FIGS. 3A and 3B), and the ignitability of the air-fuel mixture is secured. This enables misfire in the internal combustion engine 1 to be avoided and enables traveling to be smoothly recovered from emergency braking or sudden braking. The control device 12 thereafter determines whether or not normal combustion is performed (step S13). In this determination, for example, a determination may be made based on torque fluctuation or a combustion pressure monitor of the internal combustion engine 1, or a determination may be made by assuming that the normal combustion is performed based on an elapsed time.

In a case where a determination is made that the normal combustion is not performed in step S13 (No), the control device 12 repeats a process of step S12 and subsequent processes. That is, the retard angle is maintained at a value in the third area C, and the ignitability of the air-fuel mixture is secured. On the other hand, in a case where a determination is made that the normal combustion is performed in step S13 (Yes), in step S14, the control device 12 sets the retard angle to a prescribed value in the second area B (for example, 5° to 10°) and repeats the above procedure. The retard angle is set to a value in the second area B, and enhancement of both of the thermal efficiency and ignitability is thereby expected.

That is, the control device 12 reduces the thermal loss by setting the retard angle to a value in the first area A or the second area B in the usual operation (steps S4 and S14), sets the retard angle to a value in the third area C in a catalyst warming-up operation (step S2) and a recovery operation from emergency braking or sudden braking (step S12), thereby switches the retard angle to values in different areas, and thereby reduces the ignition delay. Accordingly, both of combustion stability and a fuel efficiency improvement by a thermal efficiency improvement may be realized. Further, the control device 12 sets the retard angle to a value not in the first area A but in the second area B in the usual operation (steps S4 and S14), and the combustion stability in the usual operation is thereby secured. In a case where the combustion stability is secured in the usual operation, the control device 12 may set the retard angle to a value in the first area A. This further reduces the thermal loss.

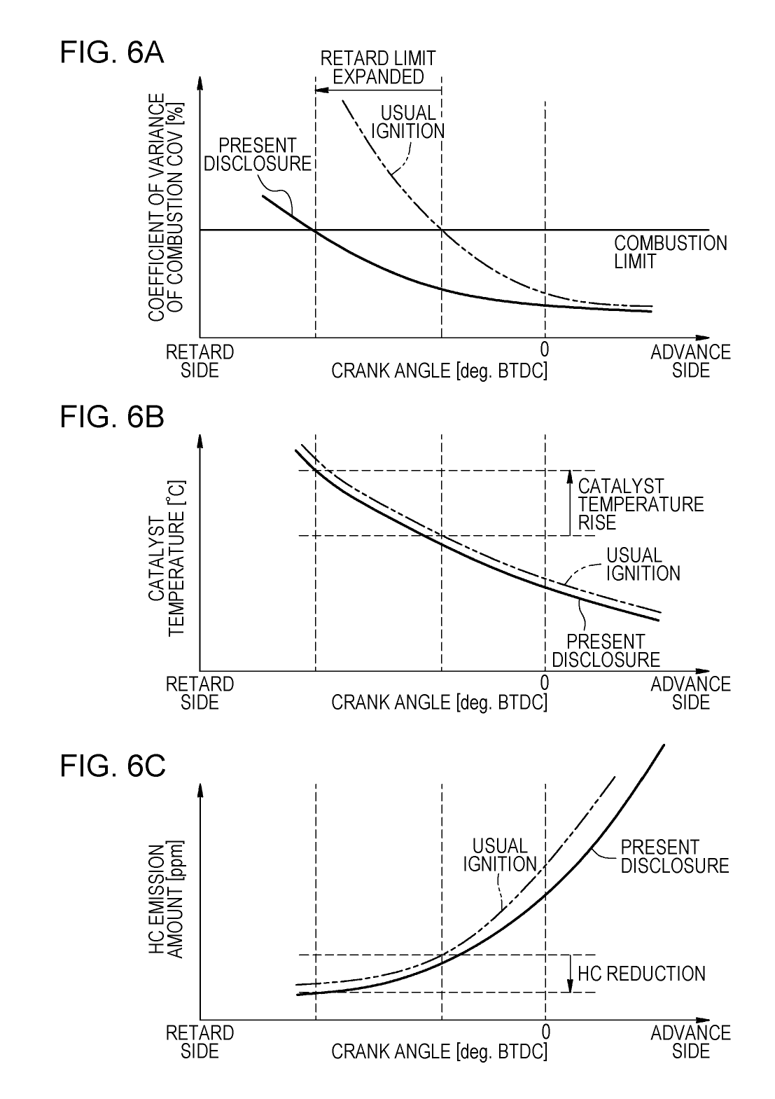

Here, a description will be made about the influence by the timing of ignition of the air-fuel mixture by the ignition plug 11 with reference to FIGS. 6A to 6C. FIG. 6A is a graph that represents the relationship between the ignition timing with the crank angle being a reference (hereinafter, simply referred to as ignition timing) and the coefficient of variance (COV) of combustion that serves as an index of the combustion stability. FIG. 6B is a graph that represents the relationship between the ignition timing and the catalyst temperature. FIG. 6C is a graph that represents the relationship between the ignition timing and an HC emission amount (concentration). In each graph, the horizontal axis is the crank angle (ignition advance angle before top dead center (BTDC)), and a crank angle of 0° indicates the compression top dead center.

As illustrated in FIG. 6A, in usual ignition in which the air-fuel mixture is ignited not by performing the non-equilibrium plasma discharge but only by the arc discharge, the coefficient of variance of combustion becomes larger (that is, the combustion stability degrades) as the ignition timing is on the more retarded side and rapidly becomes large after the compression top dead center (ATDC). Thus, the ignition timing at the coefficient of variance of combustion at the combustion limit (hereinafter referred to as retard limit) is relatively early (the absolute value of a crank angle, which is a negative value in the BTDC range, is small). On the other hand, in the ignition according to the present disclosure in which the air-fuel mixture is ignited by the arc discharge after the non-equilibrium plasma discharge is performed, the coefficient of variance of combustion has a milder increasing tendency and does not becomes large very rapidly even if the ignition timing is on the more retarded side. Accordingly, the retard limit becomes late (the absolute value of a crank angle, which is a negative value in the BTDC range, is large) and is thereby expanded.

As illustrated in FIG. 6B, the catalyst temperature tends to increase as the ignition timing is on the more retarded side because the exhaust gas temperature rises as the ignition timing is on the more retarded side. Although there is not a very large difference in the tendency of the catalyst temperature in accordance with the ignition timing between the usual ignition and the ignition according to the present disclosure, the catalyst temperature of the ignition according to the present disclosure is slightly low compared to the usual ignition. However, in the ignition according to the present disclosure, because the retard limit indicated in FIG. 6A is expanded, the ignition timing may be retarded, and the catalyst temperature may thereby be increased.

As illustrated in FIG. 6C, the HC emission amount tends to increase as the ignition timing is on the more advanced side. Although there is not a very large difference in the tendency of the HC emission amount in accordance with the ignition timing between the usual ignition and the ignition according to the present disclosure, the HC emission amount of the ignition according to the present disclosure is slightly large compared to the usual ignition. However, in the ignition according to the present disclosure, because the retard limit indicated in FIG. 6A is expanded, the ignition timing may be retarded, and the HC emission amount may thereby be reduced.

Accordingly, in a case where the retard angle is set to a value in the third area C, which is larger than a value in the second area B in step S4, in step S2 of FIG. 4 and a case where the retard angle is set to a value in the third area C, which is larger than a value in the second area B in step S14, in step S12 of FIG. 5, the arc discharge timing is set to the retard side compared to the usual operation, thereby increasing the retard angle.

A specific example will be described with reference to FIG. 4. The control device 12 sets the arc discharge timing (ignition timing) to minimum advance for the best torque (MBT) in step S4, for example, sets the non-equilibrium plasma discharge timing to a value, which is 5° to 10° on the more advanced side with respect to the arc discharge timing, and thereby sets the retard angle to a value in the second area B. Meanwhile, the control device 12 maintains the arc discharge timing at the MBT in step S2, sets the non-equilibrium plasma discharge timing to a value, which is 10° to 13° on the more advanced side with respect to the arc discharge timing, and thereby sets the retard angle to a value in the third area C. The retard angle is similarly set in the discharge control in the usual operation of FIG. 5. The arc discharge timing is not limited to the MBT but may be a fixed value such as the compression top dead center (TDC), for example.

As described above, in a case where the warming-up of the catalyst subsequent to the engine start is desired (step S1: Yes) and a case where recovery from emergency braking or sudden braking is desired (step S11: Yes), the arc discharge timing is set to the retard side (steps S2 and S12) compared to the usual operation (steps S4 and S14). Accordingly, quick activation of the catalyst may be secured by a rise in the exhaust gas temperature, and the combustion stability may be secured by an ignitability improvement of the air-fuel mixture. Consequently, hydrocarbon in the exhaust gas may be reduced. As described above, the retard angle is set to a value in the second area B in the usual operation (steps S4 and S14), and enhancement of both of the thermal efficiency and ignitability is thereby expected.

That is, in an operation state where the combustion stability is low compared to the usual operation (steps S4 and S14) such as a case where the warming-up of the catalyst subsequent to the engine start is desired (step S2) and a case where recovery from emergency braking or sudden braking is desired (step S12), the control device 12 sets the retard angle large compared to the usual operation. Accordingly, the combustion stability is secured, and the thermal loss is reduced in the whole operation range of the internal combustion engine 1.

### Modification Example

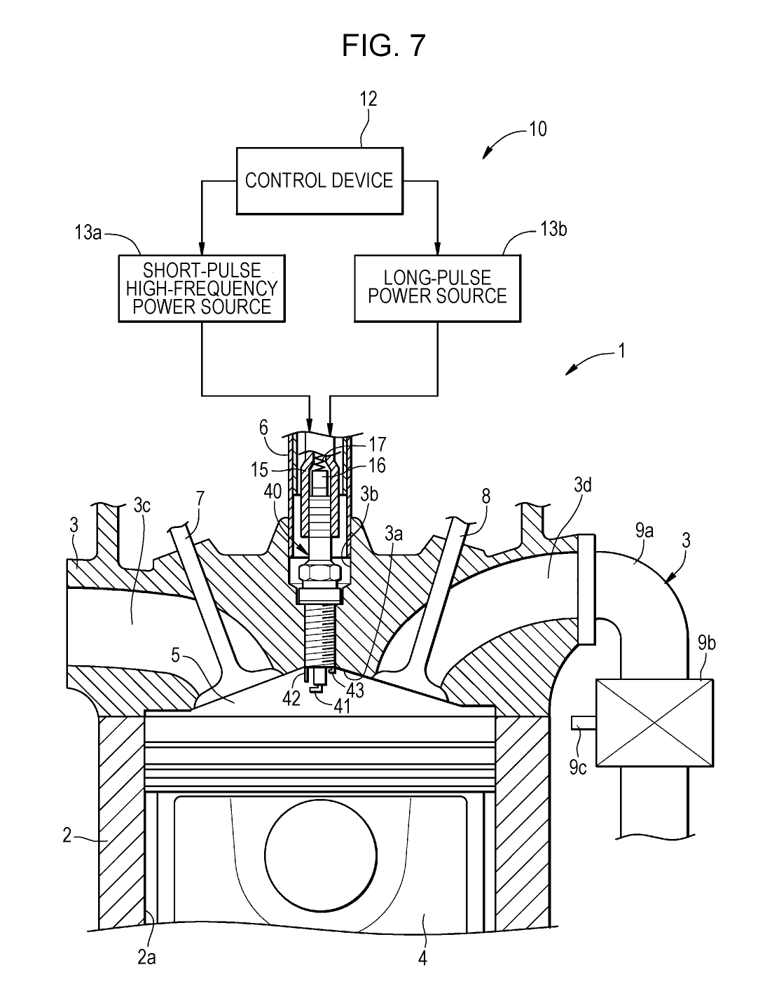

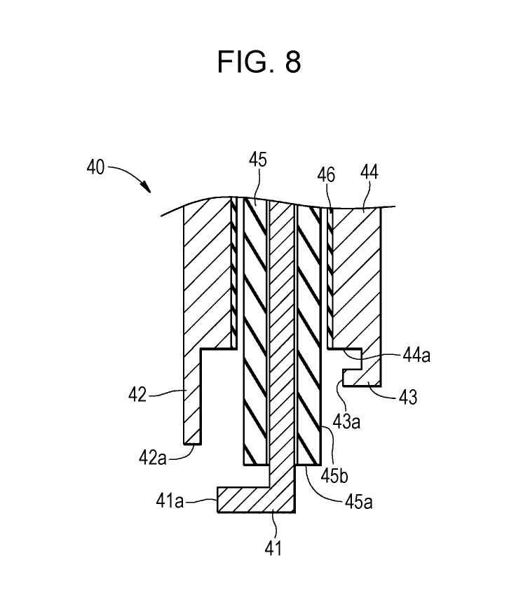

FIG. 7 illustrates the internal combustion engine 1 that includes the ignition device 10 according to a modification example of the first embodiment. FIG. 8 is a cross-sectional view that enlarges a lower portion of an ignition plug 40 illustrated in FIG. 7. In this modification example, a form of the ignition plug 40 is different from the above embodiment. Elements that have a form or a function similar to or same as the first embodiment are provided with the same reference characters, and descriptions thereof will not be repeated. The same applies to a second embodiment, which will be described later.

As illustrated in FIG. 7, the ignition plug 40 has three electrodes 41 to 43 (hereinafter referred to as first electrode 41, second electrode 42, and third electrode 43) at a tip (lower end) and the terminal portion 16 at a base end (upper end). The first electrode 41 arranged on the central axis of the ignition plug 11 is a center electrode that is electrically connected with the power source 13 via the terminal portion 16.

As illustrated in FIG. 8, a tip portion of the ignition plug 40 has a male thread (not illustrated) formed on an outer peripheral surface and has a cylindrical main portion 44 that is electrically connected with the cylinder head 3 and a tubular insulator 45 that is inserted in an internal portion of the main portion 44. An insulating film 46 formed of a material with a low dielectric constant compared to the insulator 45 is formed on an inner surface of the main portion 44. The insulator 45 has a tubular shape and houses the first electrode 41 in an internal portion. The insulator 45 extends to a position below a tip surface 44a of the main portion 44. The first electrode 41 extends to a position further below a tip portion 45a of the insulator 45 and then bends to extend outward in the radial direction. The second electrode 42 and the third electrode 43 are integrally provided in the tip surface 44a of the main portion 44 to extend downward. The second electrode 42 and the third electrode 43 are arranged in positions opposed to each other across the first electrode 41.

The second electrode 42 is formed into a rod shape and linearly extends downward from an outer peripheral portion of the main portion 44. The second electrode 42 is formed longer than the third electrode 43, and a tip portion 42a of the second electrode 42 is arranged in a vicinity of an outside end 41a of the first electrode 41 in the radial direction. Meanwhile, the third electrode 43 linearly extends downward from an outer peripheral portion of the main portion 44 but is shorter than the second electrode 42 and then bends to extend inward in the radial direction. An inward-directed tip portion 43a (an end surface on the inside in the radial direction) of a bent portion of the third electrode 43 is arranged close to an outer surface 45b of the insulator 45 compared to the second electrode 42.

Also in the ignition device 10 with the ignition plug 11 configured as described above, the control device 12 controls the applied voltage to the ignition plug 11 and may thereby switch the discharge modes of the ignition plug 11 between the non-equilibrium plasma discharge and the arc discharge. Specifically, the control device 12 applies high-frequency short pulses at a relatively low voltage to the ignition plug 11 from the short-pulse high-frequency power source 13a, and the non-equilibrium plasma discharge (dielectric barrier discharge) is thereby caused between the third electrode 43 and the first electrode 41, that is, between the inward-directed tip portion 43a of the third electrode 43 and the outer surface 45b of the insulator 45. Further, the control device 12 applies long pulses at a relatively high voltage from the long-pulse power source 13b or long pulses at a relatively high voltage from the short-pulse high-frequency power source 13a to the ignition plug 11, and the arc discharge is thereby caused between the second electrode 42 and the first electrode 41, that is, between the tip portion 42a of the second electrode 42 and the outside end 41a of the first electrode 41 in the radial direction.

Also in a case where such an ignition device 10 is provided in the internal combustion engine 1, the ignition device 10 controls the start timing of the non-equilibrium plasma discharge and the start timing of the arc discharge in accordance with the operation state, similarly to the above, and changes the retard angle. Accordingly, the same effect as the above may be obtained.

### Second Embodiment

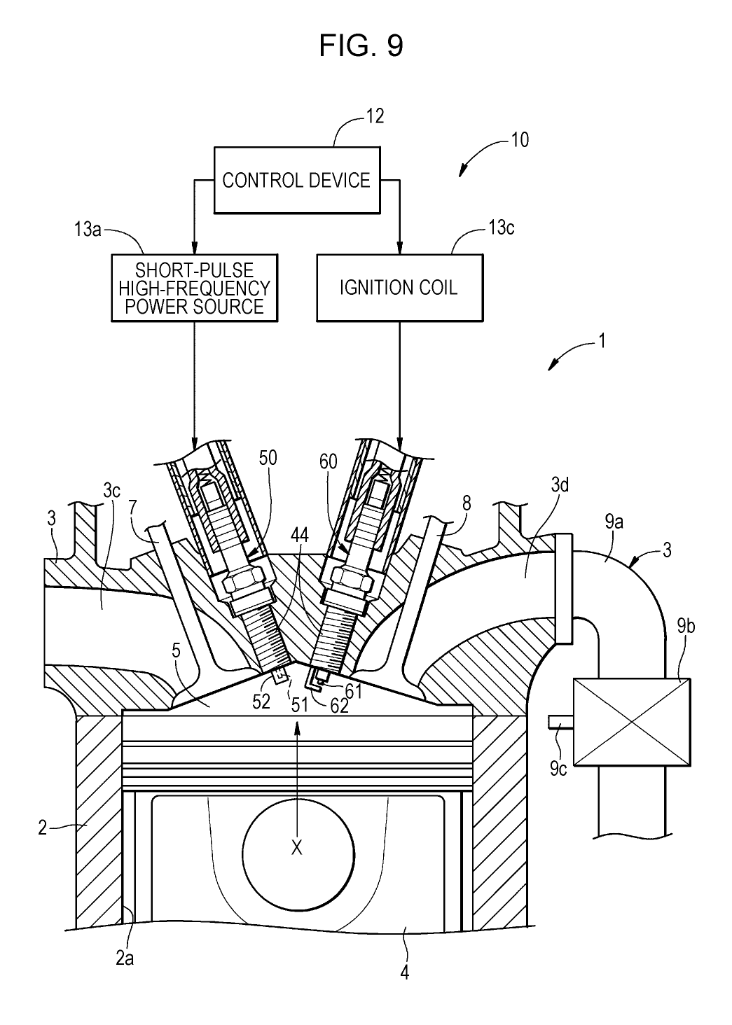

A description will next be made about the ignition device 10 of the internal combustion engine 1 according to the second embodiment with reference to FIGS. 9 to 11C. In the ignition device 10 of this embodiment, two plugs (50 and 60) are provided for one cylinder 2a. Further, as the power source 13, the short-pulse high-frequency power source 13a and an ignition coil 13c are provided. A first ignition plug 50 is for the non-equilibrium plasma discharge, and a second ignition plug 60 is for the arc discharge.

The first ignition plug 50 has a high-voltage electrode 51 that is formed of a conductive material and has a covering portion covered by a dielectric 52. The control device 12 applies high-frequency short pulses at a relatively low voltage from the short-pulse high-frequency power source 13a to the first ignition plug 50, and the first ignition plug 50 thereby performs the non-equilibrium plasma discharge. Meanwhile, the second ignition plug 60 has a first electrode 61 and a second electrode 62, which are similar to the first embodiment. The control device 12 applies long pulses at a relatively high voltage from the ignition coil 13c to the second ignition plug 60, and the second ignition plug 60 thereby performs the arc discharge. Control of the non-equilibrium plasma discharge and the arc discharge is similar to the first embodiment.

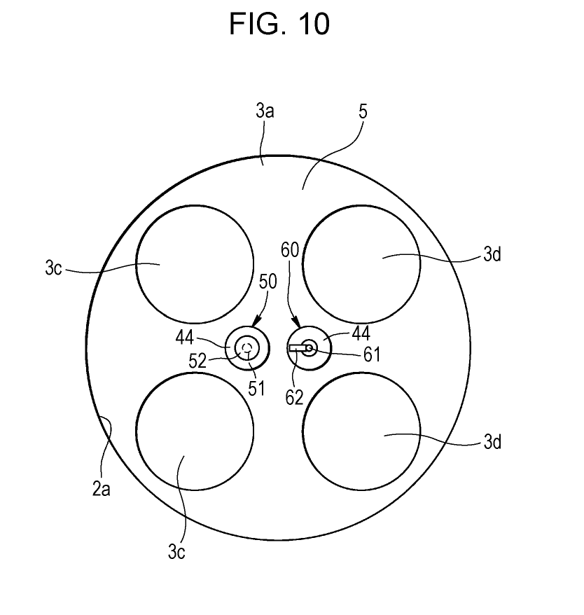

As together illustrated in FIG. 10, the internal combustion engine 1 is a four-valve engine in which two intake ports 3c (intake valves 7) and two exhaust ports 3d (exhaust valves 8) are formed for one cylinder 2a. The first ignition plug 50 and the second ignition plug 60 are arranged in a space on an inner side of the four ports, arranged to be inclined such that tips of the first ignition plug 50 and the second ignition plug 60 are close to each other at the center of the top portion of the combustion chamber 5, and mounted on the cylinder head 3 in a V shape in a side view (FIG. 9). The first ignition plug 50 is arranged to be inclined with respect to the cylinder axis between the two intake ports 3c (the intake valve 7 side). The second ignition plug 60 is arranged to be inclined with respect to the cylinder axis between the two exhaust ports 3d (the exhaust valve 8 side).

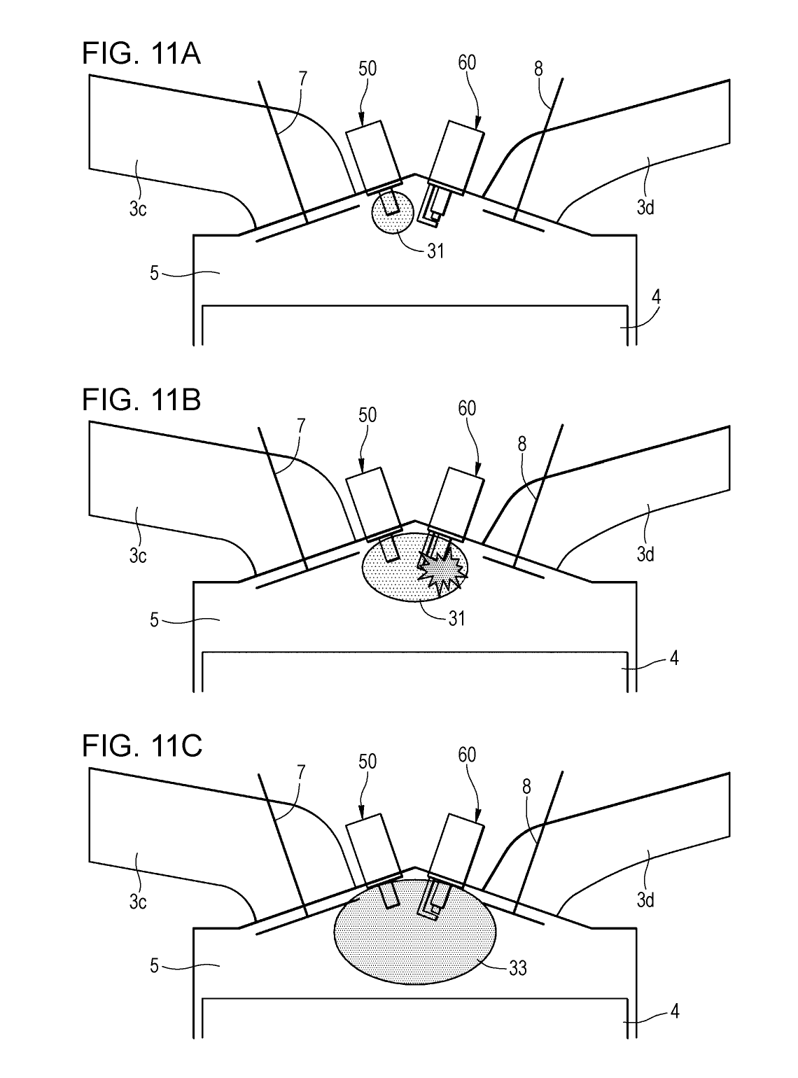

In the internal combustion engine 1 with the ignition device 10 configured as described above, ignition of the mixed gases and combustion of the ignited mixed gases progress as described below. That is, as illustrated in FIG. 11A, the first ignition plug 50 first performs the non-equilibrium plasma discharge. Accordingly, the non-equilibrium plasma that generates radicals generates the active field 31 around the tip of the first ignition plug 50, that is, the center of the top portion of the combustion chamber 5. The generated active field 31 is moved toward the exhaust side by a flux of the air-fuel mixture. As illustrated in FIG. 11B, the second ignition plug 60 thereafter performs the arc discharge and thereby ignites the air-fuel mixture in the active field 31. Here, because the first ignition plug 50 is arranged on the intake side, the arc discharge is certainly performed in the active field 31. As illustrated in FIG. 11C, the flame 33 ignited at the tip (between the pair of electrodes 61 and 62) of the second ignition plug 60 speedily propagates in the active field 31 while spreading from the center of the combustion chamber 5, and combustion of the air-fuel mixture is quickly completed.

Also in a case where the internal combustion engine 1 is configured as described above, the ignition device 10 controls the start timing of the non-equilibrium plasma discharge and the start timing of the arc discharge in accordance with the operation state, similarly to the above, and changes the retard angle. Accordingly, the same effect as the above may be obtained.

The foregoing is the description of the specific embodiments. However, the present disclosure is not limited to the above embodiments but may be modified in various manners. For example, in the above embodiments, a direct current pulse voltage is applied as the high-frequency short pulse. However, an alternating current voltage may be applied. Further, specific configurations, arrangement, amounts, materials, control procedures, and so forth of members and components may appropriately be changed within the scope that does not depart from the gist of the present disclosure. Further, it is not necessarily desired to employ all the configuration elements described in the above embodiments. However, configuration elements may appropriately be selected.

One aspect of the present disclosure provides an ignition device for an internal combustion engine, the ignition device including: a non-equilibrium plasma discharge unit; an arc discharge unit; and a control device that controls a non-equilibrium plasma discharge timing and an arc discharge timing which is set to a retard side by a prescribed retard angle with respect to the non-equilibrium plasma discharge timing, in which in an operation state where combustion stability is low compared to a usual operation, the control device increases the retard angle compared to the usual operation.

In such a configuration, in the operation state where the combustion stability is low, the retard angle of the arc discharge timing with respect to the non-equilibrium plasma discharge timing is increased while the thermal loss is reduced in the usual operation. Accordingly, the combustion stability may be secured in the whole operation range of the internal combustion engine.

Further, in the aspect of the present disclosure, the operation state where the combustion stability is low may include a catalyst warming-up operation that raises a temperature of a catalyst, and in the catalyst warming-up operation, the control device may increase the retard angle by setting the arc discharge timing to the retard side compared to the usual operation.

In such a configuration, quick activation of the catalyst may be performed, and hydrocarbon (HC) in exhaust gas may be reduced by securing the combustion stability.

Further, in the aspect of the present disclosure, in a case where an angle range of the retard angle is categorized into a first area that is an angle range in which an ignition delay decreases as the retard angle increases, a second area that is an angle range which abuts the first area on a side where the retard angle is larger than the first area and in which a change in the ignition delay with respect to a change in the retard angle is relatively small, and a third area that is an angle range which abuts the second area on a side where the retard angle is larger than the second area and in which the ignition delay decreases as the retard angle increases, the control device may set the retard angle to a value in the first area or the second area in the usual operation and may set the retard angle to a value in the third area in the catalyst warming-up operation.

In the third area, the ignition delay is rapidly reduced when the retard angle increases, and the combustion stability is significantly improved. On the other hand, the thermal loss significantly increases. In such a configuration, the areas are switched between the catalyst warming-up operation and the usual operation, and both of the combustion stability and fuel efficiency may thereby be enhanced.

Further, in the aspect of the present disclosure, the control device may set the retard angle to a value in the second area in the usual operation.

In such a configuration, an effect of reducing the ignition delay by the non-equilibrium plasma is scarcely exhibited in the first area. However, the retard angle is set to the second area in the usual operation, and the combustion stability in the usual operation may thereby be secured.

Further, in the aspect of the present disclosure, the operation state where the combustion stability is low may include an operation immediately subsequent to detection of sudden braking in exhaust gas recirculation, and immediately after sudden braking is detected in the exhaust gas recirculation, the control device may increase the retard angle by setting the arc discharge timing to the retard side compared to the usual operation.

In such a configuration, misfire may be avoided, and traveling may thereby be recovered smoothly after sudden braking.

Further, in the aspect of the present disclosure, in a case where an angle range of the retard angle is categorized into a first area that is an angle range in which an ignition delay decreases as the retard angle increases, a second area that is an angle range which abuts the first area on a side where the retard angle is larger than the first area and in which a change in the ignition delay with respect to a change in the retard angle is relatively small, and a third area that is an angle range which abuts the second area on a side where the retard angle is larger than the second area and in which the ignition delay decreases as the retard angle increases, the control device may set the retard angle to a value in the first area or the second area in the usual operation and may set the retard angle to a value in the third area immediately after emergency braking is detected in the exhaust gas recirculation.

In such a configuration, the combustion stability may certainly be secured.

Obviously, numerous modifications and variations of the present invention are possible in light of the above teachings. It is therefore to be understood that within the scope of the appended claims, the invention may be practiced otherwise than as specifically described herein.

What is claimed is:

1. An ignition apparatus for an internal combustion engine, the ignition device comprising:
a non-equilibrium plasma discharge unit;
an arc discharge unit; and
a control device that controls a non-equilibrium plasma discharge timing and an arc discharge timing which is set to a retard side by a prescribed retard angle with respect to the non-equilibrium plasma discharge timing,
wherein in an operation state where combustion stability is low compared to a usual operation, the control device increases the retard angle compared to the usual operation.

2. The ignition apparatus for an internal combustion engine according to claim 1,
wherein the operation state where the combustion stability is low includes a catalyst warming-up operation that raises a temperature of a catalyst, and
in the catalyst warming-up operation, the control device increases the retard angle by setting the arc discharge timing to the retard side compared to the usual operation.

3. The ignition apparatus for an internal combustion engine according to claim 2,
wherein in a case where an angle range of the retard angle is categorized into
a first area that is an angle range in which an ignition delay decreases as the retard angle increases,
a second area that is an angle range which abuts the first area on a side where the retard angle is larger than the first area and in which a change in the ignition delay with respect to a change in the retard angle is relatively small, and
a third area that is an angle range which abuts the second area on a side where the retard angle is larger than the second area and in which the ignition delay decreases as the retard angle increases,
the control device sets the retard angle to a value in the first area or the second area in the usual operation and sets the retard angle to a value in the third area in the catalyst warming-up operation.

4. The ignition apparatus for an internal combustion engine according to claim 3, wherein the control device sets the retard angle to a value in the second area in the usual operation.

5. The ignition apparatus for an internal combustion engine according to claim 1,
wherein the operation state where the combustion stability is low includes an operation immediately subsequent to detection of sudden braking in exhaust gas recirculation, and
immediately after sudden braking is detected in the exhaust gas recirculation, the control device increases the retard angle by setting the arc discharge timing to the retard side compared to the usual operation.

6. The ignition apparatus for an internal combustion engine according to claim 5,
wherein in a case where an angle range of the retard angle is categorized into
a first area that is an angle range in which an ignition delay decreases as the retard angle increases,
a second area that is an angle range which abuts the first area on a side where the retard angle is larger than the first area and in which a change in the ignition delay with respect to a change in the retard angle is relatively small, and
a third area that is an angle range which abuts the second area on a side where the retard angle is larger than the second area and in which the ignition delay decreases as the retard angle increases,
the control device sets the retard angle to a value in the first area or the second area in the usual operation and sets the retard angle to a value in the third area immediately after emergency braking is detected in the exhaust gas recirculation.

7. An ignition apparatus for an internal combustion engine, comprising:
a non-equilibrium plasma discharge device to discharge at a non-equilibrium plasma discharge timing;
an arc discharge device to discharge at an arc discharge timing;
a combustion stability determination device to determine whether a combustion stability is lower than a threshold combustion stability; and
a control device to control the non-equilibrium plasma discharge timing and the arc discharge timing to retard the arc discharge timing from the non-equilibrium plasma discharge timing by a retard angle and to increases the retard angle in a case where the combustion stability determination device determines the combustion stability is lower than the threshold combustion stability.

8. The ignition apparatus according to claim 7,
wherein the case includes a catalyst warming-up operation that raises a temperature of a catalyst, and
wherein in the catalyst warming-up operation, the control device increases the retard angle by setting the arc discharge timing to the retard side compared to a usual operation.

9. The ignition apparatus according to claim 8,
wherein in a case where an angle range of the retard angle is categorized into
a first area that is an angle range in which an ignition delay decreases as the retard angle increases,
a second area that is an angle range which abuts the first area on a side where the retard angle is larger than the first area and in which a change in the ignition delay with respect to a change in the retard angle is small compared to the first area, and
a third area that is an angle range which abuts the second area on a side where the retard angle is larger than the second area and in which the ignition delay decreases as the retard angle increases,
wherein the control device sets the retard angle to a value in the first area or the second area in the usual operation, and
wherein the control device sets the retard angle to a value in the third area in the catalyst warming-up operation.

10. The ignition apparatus according to claim 9, wherein the control device sets the retard angle to a value in the second area in the usual operation.

11. The ignition apparatus according to claim 7,
wherein the case includes an operation immediately subsequent to detection of sudden braking in exhaust gas recirculation, and
wherein immediately after sudden braking is detected in the exhaust gas recirculation, the control device increases the retard angle by setting the arc discharge timing to the retard side compared to a usual operation.

12. The ignition apparatus according to claim 11,
wherein in a case where an angle range of the retard angle is categorized into
a first area that is an angle range in which an ignition delay decreases as the retard angle increases,
a second area that is an angle range which abuts the first area on a side where the retard angle is larger than the first area and in which a change in the ignition delay with respect to a change in the retard angle is small compared to the first area, and
a third area that is an angle range which abuts the second area on a side where the retard angle is larger than the second area and in which the ignition delay decreases as the retard angle increases,
wherein the control device sets the retard angle to a value in the first area or the second area in the usual operation, and
wherein the control device sets the retard angle to a value in the third area immediately after emergency braking is detected in the exhaust gas recirculation.
